(19) United States
(12) Patent Application Publication
(10) Pub. No.: US 2022/0190754 A1
(43) Pub. Date: Jun. 16, 2022

(54) MOTOR ARRANGEMENT SYSTEM OF ENDURABLE AND ENERGY-SAVING ELECTRIC VEHICLE

(71) Applicant: Feng-Tien Chen, Taichung City (TW)

(72) Inventor: Feng-Tien Chen, Taichung City (TW)

(21) Appl. No.: 17/124,464

(22) Filed: Dec. 16, 2020

(51) Int. Cl. H02P 5/747; B60L 58/10; G07C 5/08; H02K 7/00; H02K 7/116; H02K 11/00; H02K 11/21

(52) U.S. Cl. CPC H02P 5/747; B60L 58/10; G07C 5/0825; H02K 11/21; H02K 7/116; H02K 11/0094; H02K 7/006

(57) ABSTRACT

A motor arrangement system of an endurable and energy-saving electric vehicle includes a motor unit, a detection unit, and a control unit. The motor unit includes a number of motor devices and a speed-change device. The detection unit includes a rotational speed detector that detects a rotational speed to output a rotational speed signal and an operation detector that detects an electric current of the motor devices to output an operation signal. The control unit controls supply of electric power to one to some of the motor devices according to confirmation of the rotational speed signal and the operation signal. As such, a desired number of motor devices can be selected according to a desired level of horsepower, to thereby help reduce energy consumption and also to share the risk and cost of maintenance.

### TECHNICAL FIELD OF THE INVENTION

The present invention relates to a motor arrangement system, and more particularly to a motor arrangement system of an endurable and energy-saving electric vehicle.

### DESCRIPTION OF THE PRIOR ART

With the consciousness of protection of the environment, many countries are adopting severer regulations for emission of exhaust. Electric vehicles are now becoming prevailing. However, due to the capacity limitation of batteries for vehicles, one of the primary goals of development in the industry is to reduce the consumption of electric power and thus enhancing the efficiency of use of the electric power.

### SUMMARY OF THE INVENTION

Thus, an objective of the present invention is to provide a motor arrangement system of an endurable and energy-saving electric vehicle that helps reduce the consumption of electric power.

Thus, the present invention provides a motor arrangement system of an endurable and energy-saving electric vehicle, which is connectable to a drive gearbox of the electric vehicle and comprises at least a motor unit, a detection unit, and a control unit.

The at least one motor unit comprises a number of motor devices and a speed-change device. Each of the motor devices comprises a motor spindle to output power. The number of the motor devices is defined as N. The speed-change device comprises a speed-change gear set connected to the motor spindles and an output shaft connectable to the speed-change gear set and the drive gearbox. The power of each of the motor spindles is transmitted through he speed-change gear set and the output shaft to the drive gearbox.

The detection unit comprises a rotational speed detector that is arranged to correspond to the output shaft and detects a rotational speed of the output shaft in order to output a rotational speed signal, and an operation detector that detects horsepower of the output shaft or an electric current of the motor devices in order to output an operation signal.

The control unit is electrically connected with the motor devices and the detection unit, and is operable to switch supply of electric power to one to N of the motor devices according to confirmation of the rotational speed signal and the operation signal.

The efficacy of the present invention is as follows. A number of motor devices are provided and arranged, and each of the motor spindles is connected to the speed-change gear set, so that it is possible to select a desired number of motor devices according to a desired level of horsepower, thereby helping reducing energy consumption. Further, the arrangement is made such that one single prior art motor is split into a number of motor devices so as to help share the risk and cost of maintenance and service, and being also advantageous in reducing the repairing cost of the motor unit. Since for the one single prior art motor, once malfunctioning or becoming abnormally operating, there will be risk of losing all power. Oppositely, the present invention uses an arrangement of a number of motor devices, so that when one or some of the motor devices are abnormal, it is possible to automatically switch to another one or some other ones of the motor device that are normal in order to maintain the driving operation at a safety speed to thereby ensure driving safety.

### BRIEF DESCRIPTION OF THE DRAWINGS

FIG. 1 is block diagram showing a motor arrangement system of an endurable and energy-saving electric vehicle according to a first embodiment of the present invention.

FIG. 2 is a perspective view of the first embodiment.

FIG. 3 is a cross-sectional view of the first embodiment.

FIG. 4 is a cross-sectional view showing a different form of the first embodiment.

FIG. 5 is a current-vs-rotational-speed curve diagram of the first embodiment.

FIGS. 6 and 7 are a schematic view and a partial sectional view, respectively, showing an application of the first embodiment in an electric vehicle.

FIGS. 8 and 9 are a schematic view and a partial sectional view, respectively, showing an application of a motor arrangement system of an endurable and energy-saving electric vehicle according to a second embodiment of the present invention in an electric vehicle.

FIG. 10 is block diagram showing a motor arrangement system of an endurable and energy-saving electric vehicle according to a third embodiment of the present invention.

FIG. 11 is block diagram showing a motor arrangement system of an endurable and energy-saving electric vehicle according to a fourth embodiment of the present invention.

FIG. 12 is a perspective view of the fourth embodiment.

FIG. 13 is a cross-sectional view taken along line XIII-XIII of FIG. 12.

FIG. 14 is an electric-current-vs-rotational-speed curve diagram of the fourth embodiment.

FIG. 15 is block diagram showing a motor arrangement system of an endurable and energy-saving electric vehicle according to a fifth embodiment of the present invention.

FIG. 16 is a current-vs-rotational-speed curve diagram of the fifth embodiment.

### DETAILED DESCRIPTION OF THE PREFERRED EMBODIMENT

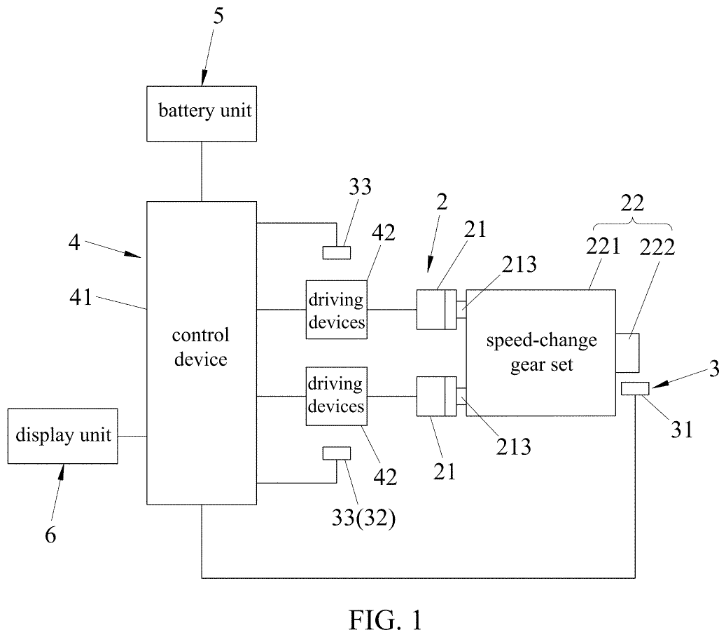

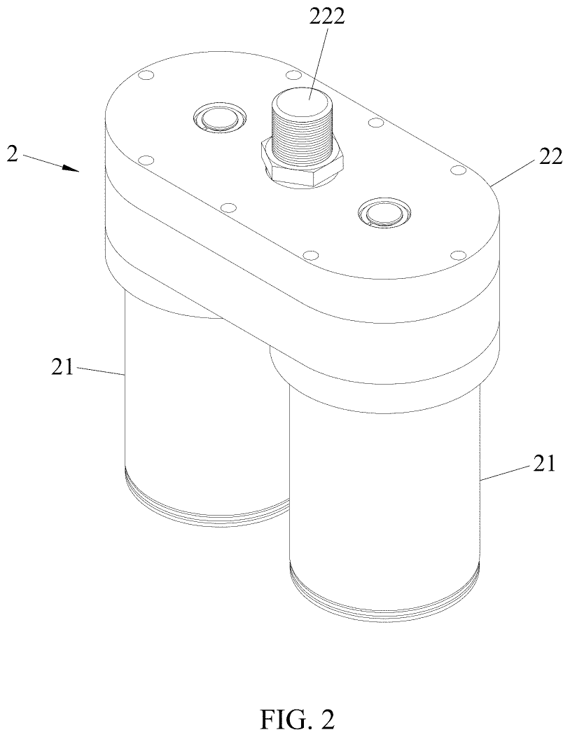

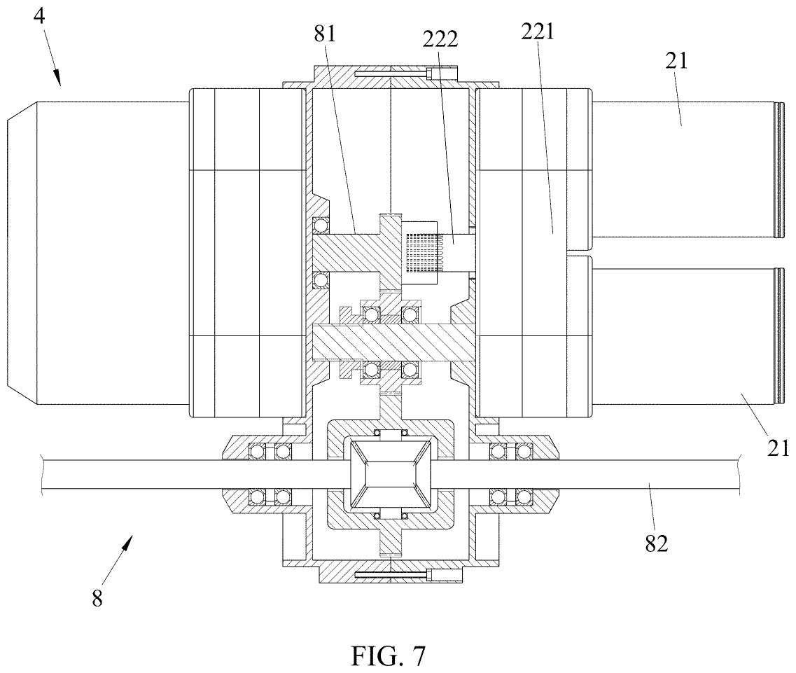

Referring to FIGS. 1, 2, 3, and 7, a motor arrangement system of an endurable and energy-saving electric vehicle according to a first embodiment of the present invention is applicable to a transmission mechanism 81 (see FIG. 7, which is generally a drive gearbox) connected to an electric vehicle and comprises a motor unit 2, a detection unit 3, a control unit 4, and a battery unit 5. The first embodiment preferably further comprises a display unit 6 in signal connection with the control unit 4.

The motor unit 2 comprises a plurality of motor devices 21 and a speed-change device 22.

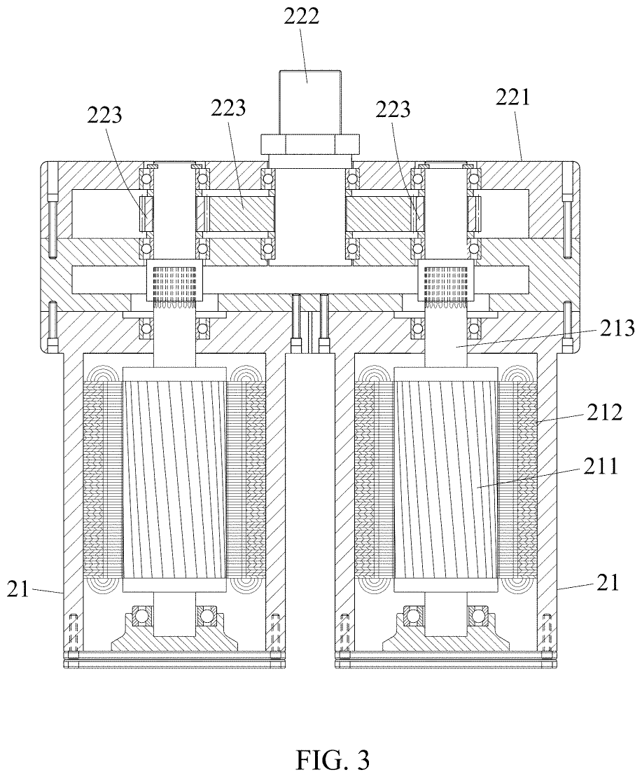

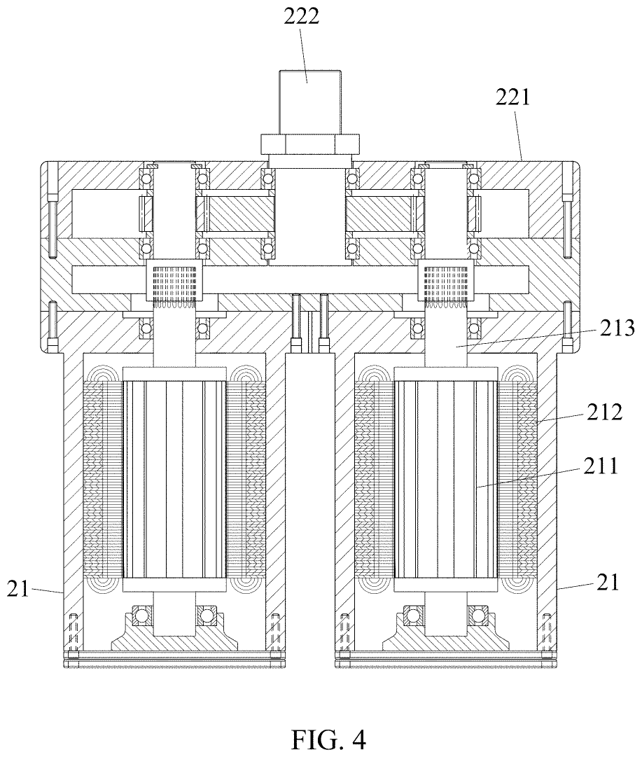

Each of the motor devices 21 comprises a rotor 211, a stator 212, and a motor spindle 213 that outputs power. The number of the motor devices 21 is defined as “N”. The motor devices 21 are preferably of a low-inertia-high-rotational-speed motor configuration, so as to be better fit to use in an electric vehicle 8. An example can be a motor configuration where the rotor inertia is lower than 0.0275 kg.m². Each of the motor devices 21 can be of an induction motor configuration, as illustrated in FIG. 3, or a synchronous motor configuration, which includes magnetic elements, as shown in FIG. 4.

Referring to FIGS. 1, 2, and 3, the speed-change device 22 comprises a speed-change gear set 221 connected to the motor spindles 213, and an output shaft 222 for connection with a speed-change gear set 221 and the transmission mechanism 81 (see FIG. 7). The speed-change gear set 221 comprises a plurality of ears 223 that mate with each other. The gears 223 function for speed reduction for the rotating power of each of the motor spindles 213 to be then transmitted through the output shaft 222 to the transmission mechanism 81 (see FIG. 7).

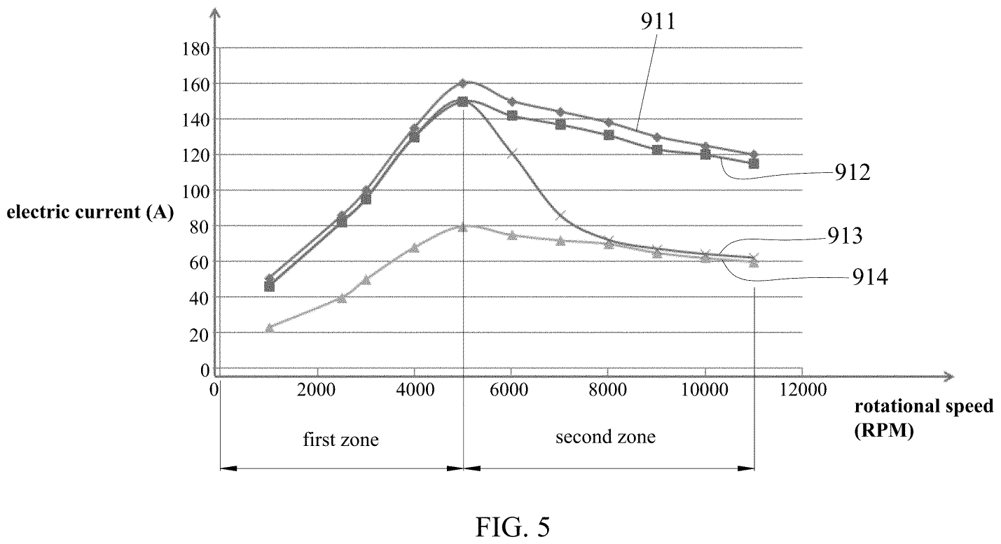

Referring to FIGS. 1 and 5, the detection unit 3 comprises a rotational speed detector 31, which is arranged to correspond to the output shaft 222 and detects a rotational speed of the output shaft 222 in order to output a rotational speed signal, an operation detector 32, which is arranged to correspond to the motor devices 21 and detects an electric current of the motor devices 21 in order to output an operation signal, and a plurality of electric current detectors 33, which respectively detect the electric currents of the motor devices 21 to output a monitoring signal. In the instant embodiment, since electric voltage and electric current of the motor devices 21 are supplied through a plurality of driving devices 42 of the control unit 4, the electric current detectors 33 are arranged to correspond to the driving devices 42, and since the electric current detectors 33 and the operation detector 32 overlap each other in respect of the functionality thereof, the electric current detectors 33 can also be used as the operation detector 32.

The control unit 4 comprises a control device 41 electrically connected with the detection unit 3 and the display unit 6 and the driving devices 42 of which the number corresponds to that of the motor devices 21 and are respectively in electric connection with the motor devices 21 and the control device 41. The control device 41 is operable to control the driving devices 42 to drive individual motor devices 21 corresponding thereto according to an operation control signal (such as a signal related to stepping on an accelerator pedal or stepping on a brake pedal) provided by a user, and is operable to switch electric power supply to one to N of the motor devices 21 according to confirmation of the rotational speed signal and the operation signal.

The control device 41 is electrically connected with the electric current detectors 33 and determines if the motor device 21 corresponding thereto is in normal operation according to the monitoring signal, and is operable to cut off electric power supply thereto when determining the motor device 21 is in abnormal operation, and make selection of another one of the motor devices 21 to switch electric power supply thereto. As such, dangers occurring in the operation of the electric vehicle resulting from power loss due to malfunctioning of the motor device 21 can be avoided, and continuous operation of the electric vehicle with a safe speed can be ensured. Thus, the endurance capability of the vehicle can be improved and operation safety of driving can be ensured. Further, it is preferred that the control device 41 displays data related to malfunction information and operation condition of the motor device 21 on the display unit 6 to allow a driver or a maintenance technician to quickly identify the malfunction information and operation condition of the motor devices 21.

Generally, abnormality of the motor device 21 exhibits on electric current. For example, when windings of the motor device 21 are burnt out or overloaded, the electric current detectors 33 may detect the electric current being excessively large, or when the windings of the motor device 21 are broken, the electric current detectors 33 may detect the electric current being excessively low. Thus, the electric current detectors 33 may detect the above-mentioned abnormalities and make the control device 41 stop electric power supply to the abnormal motor device 21 and select another one of the motor devices 21 that is in a normal condition to switch the electric power supply thereto to make up the kinetic power that originally supplied by the damaged motor device 21.

The control device 41 may be loaded therein with electric current vs rotational speed data. The data include at least a peak value and a predetermined value. According to such data, and the rotational speed signal and the operation signal, the control device 41 switches the supply of electric power supply to one to N of the motor devices 21.

According to the electric current vs rotational speed data, the control device 41 makes supply of electric power to N of the motor devices 21 before the rotational speed of the output shaft 222 has been increased to make an electric current corresponding thereto reaches a peak value, and makes supply of electric power to (N-k) of the motor devices when the rotational speed of the output shaft 222 has increased to a level to have the electric current corresponding thereto reach the peak value, where k is a positive integer smaller than N. Namely, the electric current vs rotational speed data are defined such that a first zone is defined as from the starting of the motor devices 21 to the point where the electric current reaches the peak value, and a second zone is defined as from the point where the electric current reaches the peak value to a subsequent point where the electric current reaches a first predetermined value that is lower than the peak value, wherein within the first zone, the control device 41 makes supply of electric power to N of the motor devices 21, and within the second zone, the control device 41 makes supply of electric power supply to (N-k) of the motor devices 21.

The battery unit 5 is electrically connected with the control unit 4 to supply electrical power by means of the control unit 4 to the motor devices 21 and to receive electric power generated by motor devices 21 that do not receive such electric power supply but are in operative coupling with and thus driven to rotate by the speed-change gear set 221.

The display unit 6 can be an in-car display panel that displays the data related to malfunction information and operation condition of the motor devices 21 to allow the driver to timely recognize the current status of the motor devices 21.

In FIG. 5, Curve 911 is an electric-current-vs-rotational-speed curve of a known electric vehicle motor, while Curve 912 to Curve 914 are electric-current-vs-rotational-speed curves of the first embodiment, respectively indicating electric power being supplied to two of the motor devices 21, supply of electric power being switched from two of the motor devices 21 to a single one of the motor devices 21, and electric power being supplied to a single one of the motor devices 21.

Curve 911 indicates that at a low speed of the known electric vehicle, the electric current increases with the rotational speed, and when the rotational speed reaches approximately 5000 rpm (Revolutions per Minute, RPM), the demand of electric current is reduced. Thus, to establish the configuration of the first embodiment, the motor devices 21 are properly selected so that when all the motor devices 21 are supplied with electric power, the performance indicated by the electric-current-vs-rotational-speed curve 912 is similar to that of Curve 911 of the known electric vehicle. As such, it can assure the motor arrangement system of the first embodiment can achieve the maximum horsepower similar to that of the known device.

The first zone is defined as, in the electric current vs rotational speed data, a zone from the starting of the motor devices 21 to a point where the electric current reaches the peak value, and the second zone is a zone from the point where the electric current reaches the peak value to a right-hand side terminal point (which corresponds to the first predetermined value that is lower than the peak value). In an actual application, within the first zone, since the electric vehicle is being started and accelerating, which require a large amount of horsepower, the control device 41 supplies electric power to both of the two motor devices 21 in order to provide a large output of horsepower; when the rotational speed continuously increases to reach the second zone, the electric vehicle enters a steady driving phase (generally corresponding to a speed of 60-200 kilometers per hour), so that the required amount of horsepower is reduced, and thus, switching is made to supplying of electric power to just one motor device 21. Thus, as shown in Curve 913, the consumption of electric current in the second zone is significantly lowered, and therefore, the endurance time period can be greatly increased even for the same battery capacity.

Further, since the motor device 21 that is cut off the supply of electric power is not disconnected from the speed-change gear set 221, the motor device 21 that is cut off the supply of electric power is driven by the speed-change gear set 221 to rotate and thus generate electric energy. As such, the motor device 21 enables recycle of extra kinematic energy for charging electric energy back to the battery unit 5, thereby further improving the efficiency of use of energy.

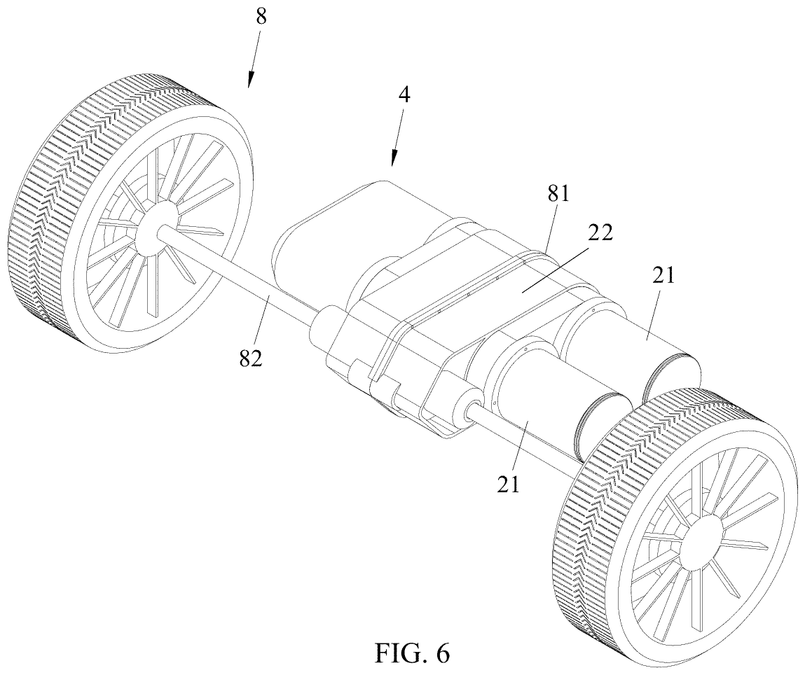

Referring to FIGS. 6 and 7, which schematically illustrate the first embodiment being mounted to an electric vehicle 8, the output shaft 222 is connectable to a transmission mechanism 81 of the electric vehicle 8 and can supply power through the transmission mechanism 81 to a wheel axle 82 of the electric vehicle 8.

Referring to FIGS. 1 and 5, based on the above description, the instant embodiment provides the following advantages:

Firstly, a plurality of motor devices 21 are arranged, and each of the motor spindles 213 is connected to the speed-change gear set 221, so that selection of a desired number of the motor devices 21 can be made according to a required level of horsepower, and this helps reduce the consumption of energy and increasing the endurance capability of the electric vehicle. Further, in the instant embodiment, it is possible to use multiple motor devices 21 that have a small horsepower output to substitute a large horsepower motor used in the prior art. For example, if the prior art requires a motor of 10 horsepower, then the first embodiment may use a combination of two 5-horsepower motor devices 21 to similarly provide the same maximum horsepower. In this way, the engagement or mating connection between each of motor device 21 and the speed-change gear set 221 only needs to support a reduced mating load, and the thickness of the gears of the speed-change gear set 221 can be reduced to thereby lower down the production and maintenance costs of the speed-change gear set 221. Further, splitting one single motor used in the prior art into a plurality of motor devices 21 also help share the maintenance risk and cost. For example, in the prior art, once the motor gets damaged, the entire device must be replaced and repaired. In the first embodiment, the probability that both the two motor devices 21 are broken at the same time is relatively low and thus, it only needs to replace and repair the damaged motor device 21 and there is no need to change all the motor devices 21 at the same time. Since a small horsepower motor device 21 has a price that is lower than a horsepower motor used in the prior art, the first embodiment is advantageous in reducing the maintenance cost of the motor unit 2.

It is noted that since the first embodiment is operable to select the number of motor devices 21 that are put into operation by switching supply of electricity or not and does not rely on mechanical switching of making engagement with the speed-change gear set 221 or not, any motor device 21 that is cut off supply of electric power maintains operatively connected to the speed-change gear set 221 and is thus driven by other ones of the motor device 21 that are in operation to rotate, so that the motor device 21 that is cut off supply of electric power does not initiate a process of repeated shut-down and starting during the driving of the electric vehicle, and therefore, there will be no issue of consumption of electric energy due to repeatedly providing torque for starting.

Secondly, the control unit 4 controls the number of the motor devices 21 to which the supply of electricity is switched according to the electric current vs rotational speed data, so that based on the status of driving or operation of the electric vehicle, the supply of electricity can be switched to only a reduced number of the motor devices 21 in a condition of high rotational speed and low horsepower. As such, unnecessary consumption of energy can be reduced, and also, being operable in combination with the battery unit 5 accepting the electric energy recycled from the ones of the motor devices 21 that are supplied with electricity would further improve the utilization efficiency of energy. Particularly, in the future when the electric vehicles are getting significantly prevailing, improving energy utilization efficiency would help reduce the trend of increasing the demand of power generation, reducing the loading of power plants, complying to the trend of environmental protection.

Thirdly, the electric current detectors 33 are arranged, together with the arrangement of the control device 41, to monitor and control the monitoring signal, and to determine if the motor devices 21 corresponding thereto are abnormal in operation, so that supply of electricity thereto is cut off and another one of the motor devices 21 is selected to receive the supply of electricity. In this way, the advantage of installation of multiple motor devices 21 can be better exploited to enable use of one of the motor devices 21 that is in a good operation condition to temporarily take the place of a damaged or malfunctioning motor device 21, and the risk occurring in an electric vehicle that is being driven and set in movement resulting from power loss due to the damage of the motor device 21 can be avoided, and it can assure that the electric vehicle is kept in driving operation at a safe speed and the endurance capability of the vehicle is improved to ensure driving safety. Further, with the arrangement of the display unit 6, data related to malfunction information and operation condition of the motor device 21 can be displayed to enable the driver or a maintenance technician to quickly identify the related data for carrying out necessary treatment.

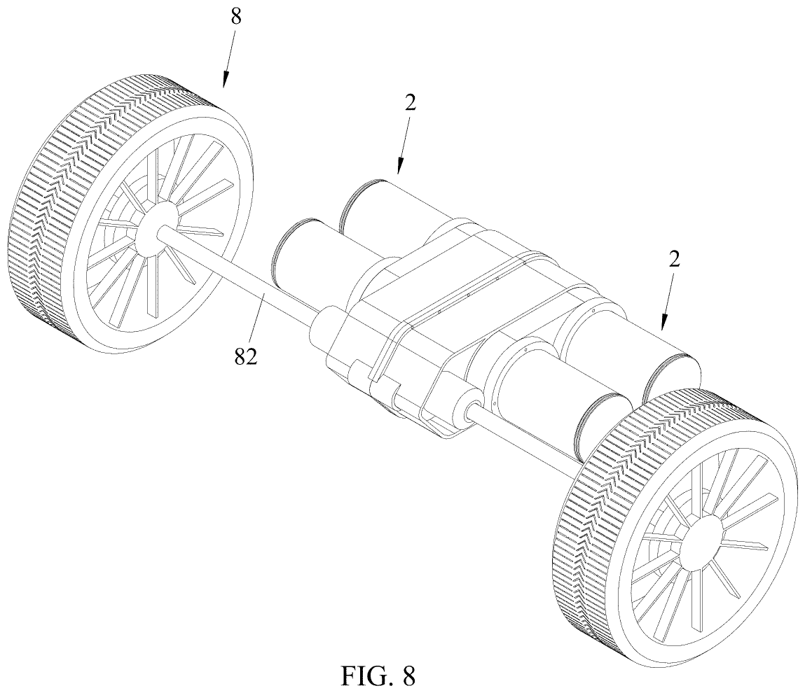

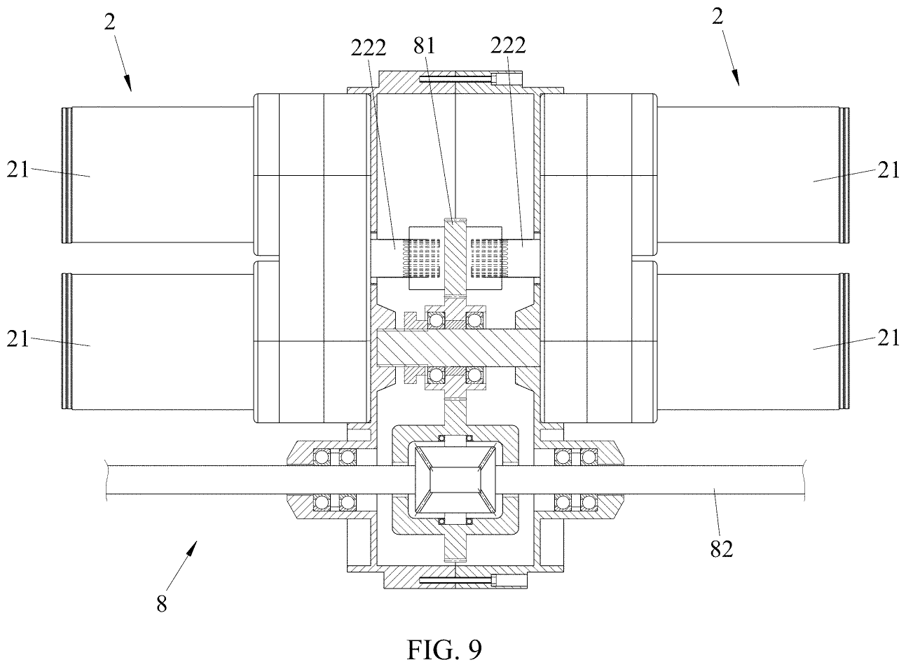

Referring to FIGS. 8 and 9, a motor arrangement system of an endurable and energy-saving electric vehicle according to a second embodiment of the present invention is provided. The second embodiment is generally similar to the first embodiment, and a difference of the second embodiment from the first embodiment resides in the following:

The second embodiment comprises two motor units 2. The motor units 2 are preferably mounted on the electric vehicle 9 in a symmetric manner Similarly, the output shaft 222 is connectable to the transmission mechanism 81 and transmits power through the transmission mechanism 81 to the wheel axle 82.

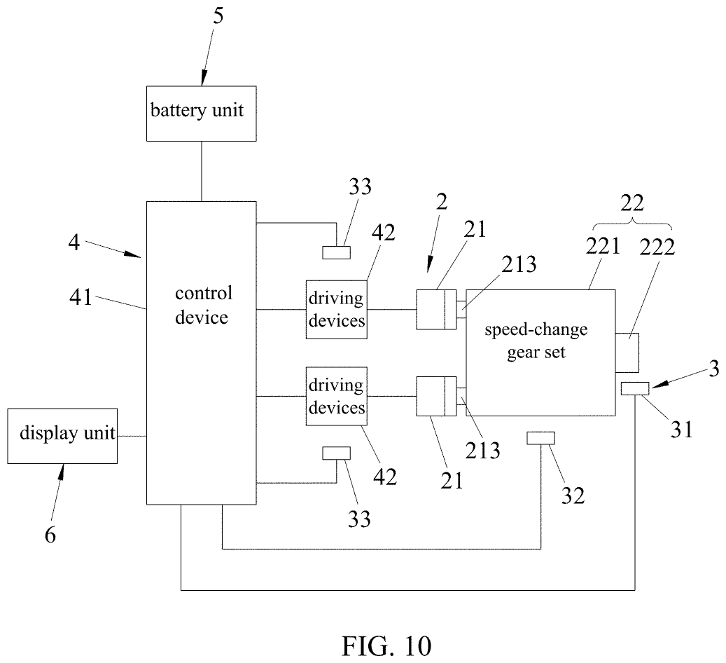

Referring to FIG. 10, a motor arrangement system of an endurable and energy-saving electric vehicle according to a third embodiment of the present invention is provided. The third embodiment is similar to the first embodiment, and a difference of the third embodiment from the first embodiment resides in the following:

The operation detector 32 detects the horsepower of the output shaft 222 to output the operation signal. The operation detector 32 can be mounted on the speed-change gear set 221 at a location corresponding to the output shaft 222, or can alternatively be mounted to directly correspond to the output shaft 222. Since horsepower is not a value that can be directly measured, in practice, the operation detector 32 may be operable to detect the torque of the output shaft 222, which can be used in combination with the rotational speed detected by the rotational speed detector 31 to calculate the value of horsepower for outputting the operation signal. A simple formula related to this is provided below:

Power=Force*Speed;

where “Power” indicates horsepower; “Force” is the torqued detected; and “Speed” is the detected value of the rotational speed. Further details can be contemplated by those having ordinary skill in the art based on the description above, there is no need to provide further details herein.

The control device 41 stores therein the horsepower vs rotational speed data. Based on such data, and confirmation of the rotational speed signal and the operation signal, switching is made to one to N of the motor devices 21 for supply of electric power thereto.

Referring to FIGS. 10 and 5, since horsepower and electric current are related to each other, and a formula between the two is as follows:

horsepower (kW)=electric voltage (V)*electric current (A)*\sqrt{3};

From the above formula, one can see that horsepower is proportional to electric current, and thus, a diagram of horsepower-vs-rotational speed curve would look similar to the diagram of electric-current-vs-rotational-speed curve shown in FIG. 5. Thus, the way of control the switching is similar to that of the first embodiment. The difference is simply minor detail that can be contemplated by those having ordinary skill in the art based on the description above, there is no need for further description herein.

The control device 41 is operable in combination with the value of horsepower detected by using the operation detector 32 to determine if the operation of the output shaft 213 of the motor device 21 is abnormal, and, in case of the determination being made that there is abnormality, to similarly cut off the supply of electricity to the motor device 21 corresponding thereto, and selection of another one of the motor devices 21 that is of a good condition for switching thereto the supply of electricity, in order to make up the kinematic energy necessary for operation.

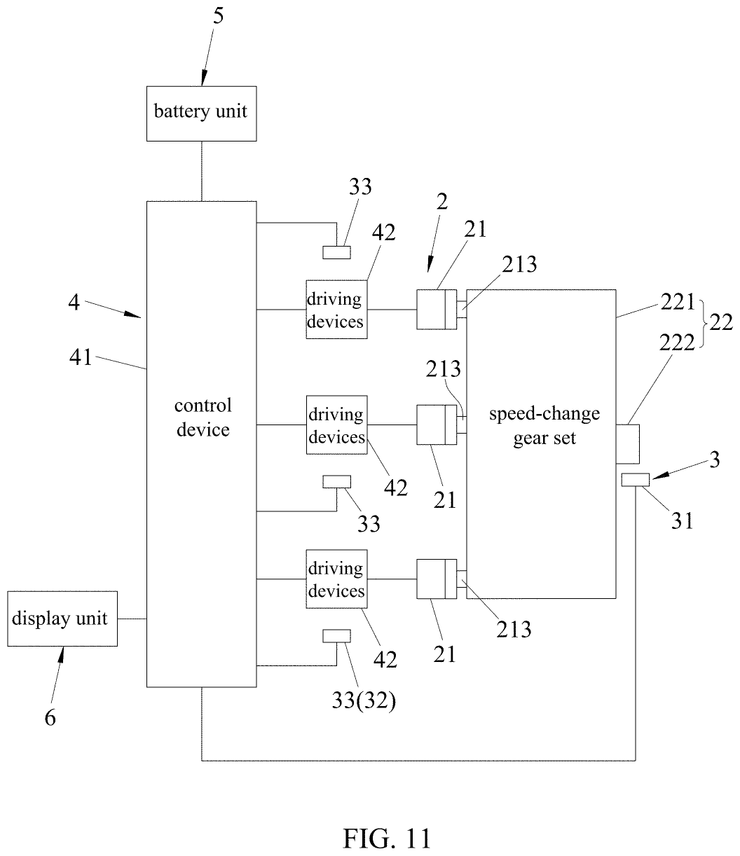

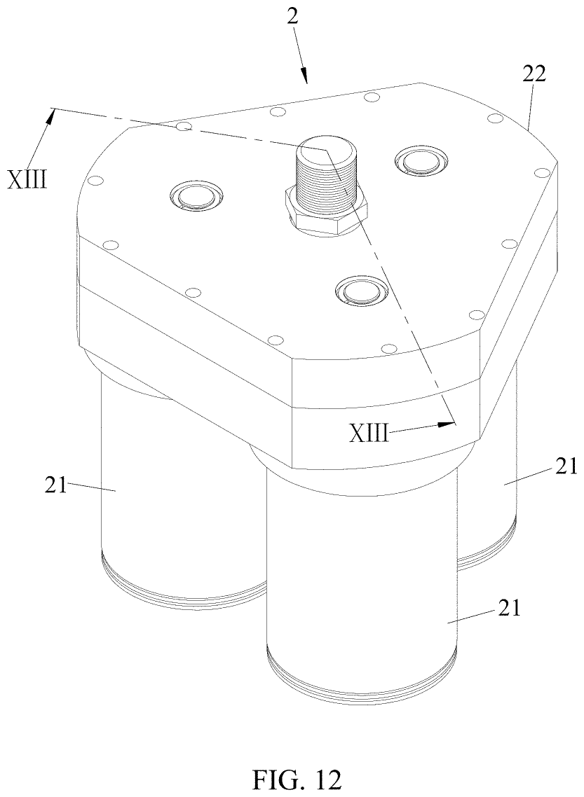

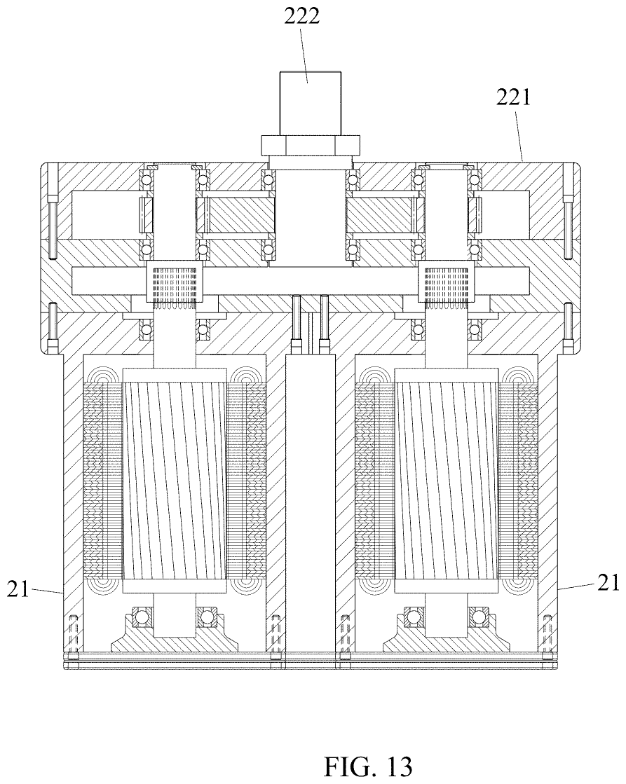

As such, the third embodiment also achieves the same purpose and effectiveness as the first embodiment described above. Referring to FIGS. 11, 12, 13, and 14, a motor arrangement system of an endurable and energy-saving electric vehicle according to a fourth embodiment of the present invention is shown. The fourth embodiment is similar to the first embodiment, and a difference of the fourth embodiment from the first embodiment resides in the following:

The motor unit 2 comprises three motor devices 21.

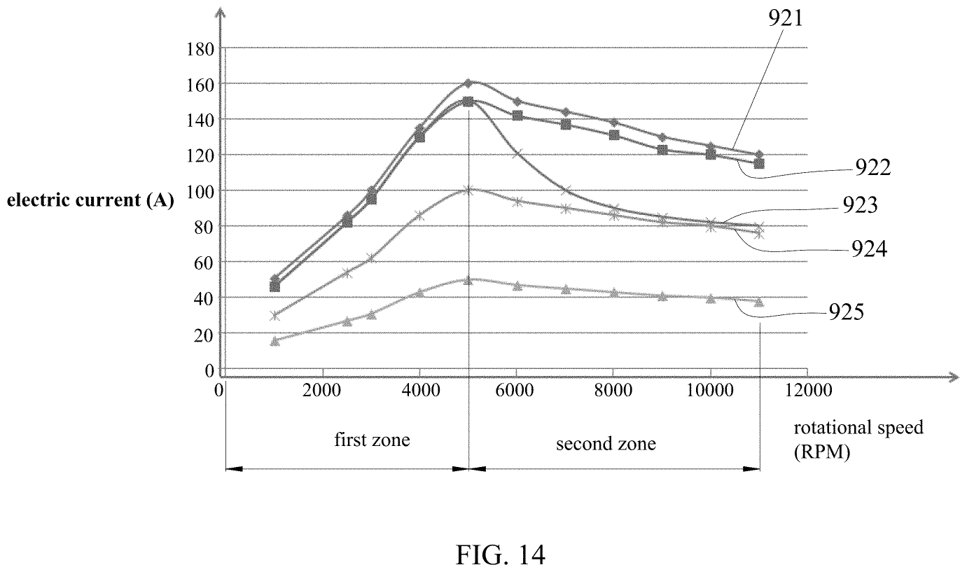

In FIG. 14, Curve 921 is an electric-current-vs-rotational-speed curve of a known electric vehicle motor, while Curve 922 to Curve 925 are electric-current-vs-rotational-speed curves of the fourth embodiment, respectively indicating electric power being supplied to three motor devices 21, supply of electric power being switched from three motor devices 21 to two motor devices 21, electric power being supplied to two motor devices 21, and electric power being supplied to one motor device 21.

To establish the configuration of the fourth embodiment, the motor devices 21 are properly selected so that when all the motor devices 21 are supplied with electric power, the performance indicated by the electric-current-vs-rotational-speed curve 922 is similar to that of Curve 921 of the known electric vehicle. As such, it can assure the motor arrangement system of the fourth embodiment can achieve the maximum horsepower similar to that of the known device.

Similarly, the first zone is defined as, in the electric current vs rotational speed data, a zone from the starting of the motor devices 21 to a point where the electric current reaches the peak value, and the second zone is a zone from the point where the electric current reaches the peak value to a right-hand side terminal point (which corresponds to the first predetermined value that is lower than the peak value). In an actual application, within the first zone, the control device 41 supplies electric power to all the three motor devices 21, and when the rotational speed continuously increases to reach the second zone, switching is made to supplying electric power to only two motor devices 21. Thus, as shown in Curve 923, the consumption of electric current in the second zone is significantly lowered, and therefore, the endurance time period can be greatly increased, and energy can be recycled for charging back into the battery unit 5 for reuse.

As such, the fourth embodiment also achieves the same purpose and effectiveness as the first embodiment. Further, since in the fourth embodiment, there are, to the minimum, at least two of the motor devices 21 are preserved, it is possible to stably supply a heightened level of horsepower and is thus suitable for large vehicles, such as buses and trucks that require a high level of horsepower.

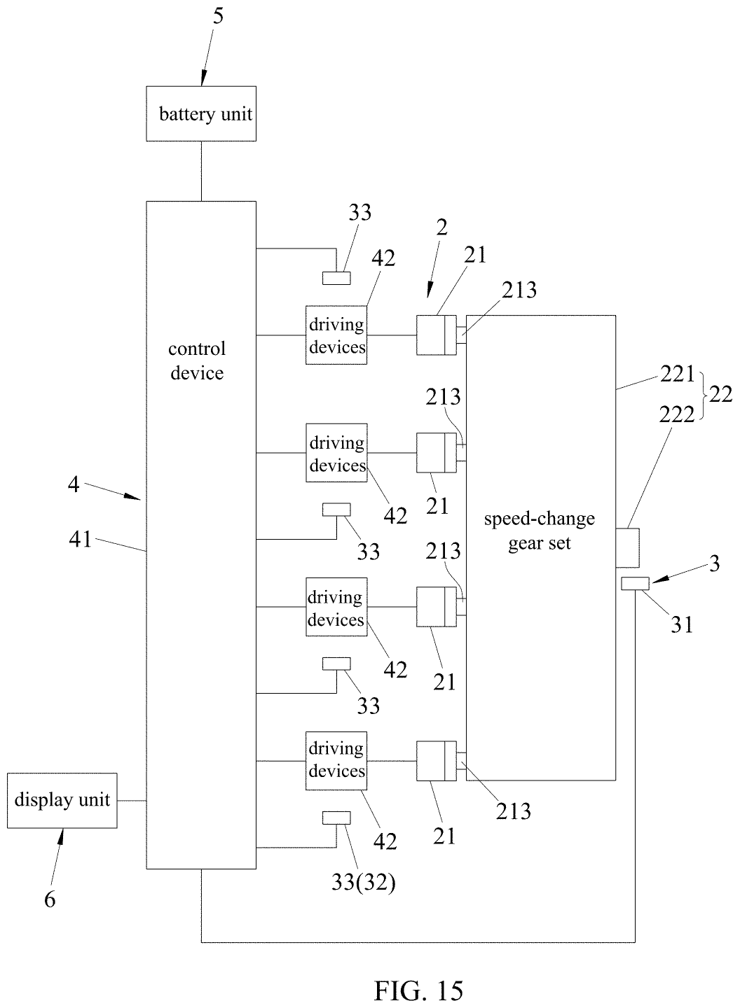

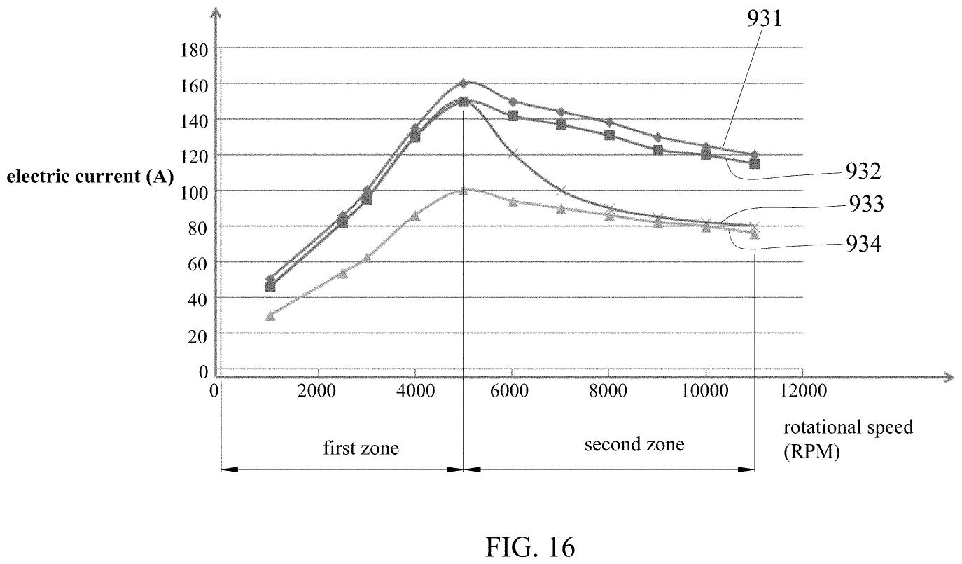

Referring to FIGS. 15 and 16, a motor arrangement system of an endurable and energy-saving electric vehicle according to a fifth embodiment of the present invention is shown. The fifth embodiment is similar to the first embodiment, and a difference of the fifth embodiment from the first embodiment resides in the following:

The motor unit 2 comprises four motor devices 21.

In FIG. 16, Curve 931 is an electric-current-vs-rotational-speed curve of a known electric vehicle motor, while Curve 932 to Curve 934 are electric-current-vs-rotational-speed curves of the fifth embodiment, respectively indicating electric power being supplied to four motor devices 21, supply of electric power being switched from four motor devices 21 to two motor devices 21, and electric power being supplied to two motor devices 21.

To establish the configuration of the fifth embodiment, the motor devices 21 are properly selected so that when all the motor devices 21 are supplied with electric power, the performance indicated by the electric-current-vs-rotational-speed curve 932 is similar to that of Curve 931 of the known electric vehicle. As such, it can assure the motor arrangement system of the fifth embodiment can achieve the maximum horsepower similar to that of the known device.

Similarly, the first zone is defined as, in the electric current vs rotational speed data, a zone from the starting of the motor devices 21 to a point where the electric current reaches the peak value, and the second zone is a zone from the point where the electric current reaches the peak value to a right-hand side terminal point (which corresponds to the first predetermined value that is lower than the peak value). In an actual application, within the first zone, the control device 41 supplies electric power to all the four motor devices 21, and when the rotational speed continuously increases to reach the second zone, switching is made to supplying electric power to only two motor devices 21. Thus, as shown in Curve 933, the consumption of electric current in the second zone is significantly lowered, and therefore, the endurance time period can be greatly increased, and energy can be recycled for charging back into the battery unit 5 for reuse.

As such, the fifth embodiment also achieves the same purpose and effectiveness as the first embodiment. Further, since in the fifth embodiment, there are, to the minimum, at least two of the motor devices 21 are preserved and, maximally, the horsepower from the four motor devices 21 can be provided, it is possible to stably supply a heightened level of horsepower and is thus suitable for large vehicles, such as buses and trucks that require a high level of horsepower. In summary, the motor arrangement system of the endurable and energy-saving electric vehicle according to the present invention can actually achieve the purpose of the present invention.

I claim:

1. A motor arrangement system of an endurable and energy-saving electric vehicle, adapted to being connected to a drive gearbox of an electric vehicle, comprising:
at least one motor unit, which comprises a number of motor devices and a speed-change device, each of the motor devices comprising a motor spindle to output power, the number of the motor devices being defined as N, the speed-change device comprising a speed-change gear set connected to the motor spindles and an output shaft connectable to the speed-change gear set and the drive gearbox, the power of each of the motor spindles being transmitted through he speed-change gear set and the output shaft to the drive gearbox;
a detection unit, which comprises a rotational speed detector that is arranged to correspond to the output shaft and detects a rotational speed of the output shaft in order to output a rotational speed signal, and an operation detector that detects horsepower of the output shaft or an electric current of the motor devices in order to output an operation signal; and
a control unit, which electrically connected with the motor devices and the detection unit, and is operable to switch supply of electric power to one to N of the motor devices according to the rotational speed signal and the operation signal.

2. The motor arrangement system of the endurable and energy-saving electric vehicle according to claim 1, wherein the control unit is loaded with horsepower-vs-rotational-speed data or electric-current-vs-rotational-speed data, and the control unit switches the supply of electric power to the one to N of the motor devices according to the data, and confirmation of the rotational speed signal and the operation signal.

3. The motor arrangement system of the endurable and energy-saving electric vehicle according to claim 2, wherein according to the electric-current-vs-rotational-speed data, the control unit controls the supply of electric power to the N motor devices at a point where the rotational speed of the output shaft is not so increased as to have the electric current reaching a peak value, and controls the supply of electric power to (N-k) of the motor devices at a point where the rotational speed of the output shaft is increased to such a level that the electric current is caused to reach the peak value, where k is a positive integer that is smaller than N.

4. The motor arrangement system of the endurable and energy-saving electric vehicle according to claim 2, wherein in the electric-current-vs-rotational-speed data, a first zone is defined as a zone from starting of the motor devices to a point where the electric current reaches the peak value, and a second zone is defined as a zone from the point where the electric current reaches the peak value to a point of reaching a first predetermined value that is lower than the peak value, wherein within the first zone, the control unit controls the supply of electric power to the N motor devices, and within the second zone, the control unit controls the supply of electric power to (N-k) motor devices, where k is a positive integer that is smaller than N.

5. The motor arrangement system of the endurable and energy-saving electric vehicle according to claim 1, further comprising a battery unit, wherein the battery unit is electrically connected with the control unit and supplies electric power through the control unit to the motor devices, and wherein the battery unit accepts electric energy generated by a portion of the motor devices that are not supplied with the electric power and are driven by the speed-change gear set to rotate.

6. The motor arrangement system of the endurable and energy-saving electric vehicle according to claim 1, wherein each of the motor devices has a rotor having an inertia that is lower than 0.0275 kg.m².

7. The motor arrangement system of the endurable and energy-saving electric vehicle according to claim 1, wherein the detection unit further comprises a plurality of electric current detectors, which detect electric currents of the motor devices, respectively, and individually output a monitoring signal, wherein the control unit is electrically connected with the electric current detectors and is operable to determine each of the motor devices is in normal operation according to the monitoring signal corresponding thereto, and to cut off supply of electricity to one of the motor devices that is determined to be in abnormal operation and to select another one of the motor devices for switching the supply of electricity thereto.

8. The motor arrangement system of the endurable and energy-saving electric vehicle according to claim 7, further comprising a display unit electrically connected with the control unit, the display unit being operable to display data of the abnormality of the one of the motor devices.
